(19) United States
(12) Patent Application Publication
(10) Pub. No.: US 2010/0193529 A1
(43) Pub. Date: Aug. 5, 2010

(54) GAS BOTTLE, PROTECTIVE ELEMENT FOR USE ON SUCH GAS BOTTLE, AND FILTER INTENDED TO USE WITH SUCH GAS BOTTLE

(75) Inventors: Marinus Frans van der Maas, Arnemuiden (NL); Martinus van der Maas, Middelburg (NL)

Correspondence Address: WEINGARTEN, SCHURGIN, GAGNEBIN & LEBOVICI LLP, TEN POST OFFICE SQUARE, BOSTON, MA, 02109, US

(73) Assignee: SCIENTIFIC GLASS TECHNOLOGY SINGAPORE PTE LTD., Singapore (SG)

(21) Appl. No.: 12/520,250

(22) PCT Filed: Dec. 20, 2007
(86) PCT No.: PCT/NL2007/050674

§ 371 Date: Apr. 7, 2010

(30) Foreign Application Priority Data
Dec. 22, 2006 (NL) 1033130

(51) Int. Cl. F17C 13/04; F17C 1/00

(52) U.S. Cl. 220/581; 222/3; 220/724

(57) ABSTRACT

A gas bottle (1) provided with a container (2) in which a gas, for instance an Ultra High Purity Gas is receivable, with an outlet opening (3) for letting the gas out of the container, wherein the gas bottle (1) is provided with filter means (4) for operatively filtering the gas flowing out of the container (12), wherein the container (2) comprises a protective element (6) for protecting the outlet opening (3), wherein the filter means (4) are provided downstream of the outlet opening (3), on an outside of the container (2) and are surrounded by the protective element (16) and/or the filter means (4) are arranged such that they can resist a load exerted thereon. The invention further relates to a protective element (6) and a filter (4) for use with such a gas bottle (1).

The invention relates to a gas bottle provided with a container in which a gas, for instance an Ultra High Purity Gas is receivable, with an outlet opening for letting the gas out of the container and a shut-off valve which is in fluid connection with the outlet opening, while the gas bottle is provided with a purifier for operatively purifying the gas flowing out of the container.

Such a gas bottle is known from practice and comprises an inner container partly provided in the inside of the container, in which a purifier is provided. The gas in the container, which gas may at least partly be in the liquid phase as a result of the pressure prevalent in the container, operatively flows through the purifier via a valve and reaches, via a porous element, a tap assembly for supplying the gas to, for instance, a processing module which is in fluid connection with a tap opening. Such a purifier is arranged for removing particles from the gas to obtain an Ultra High Purity Gas. With such a device, for exchanging the purifier, for instance because the purifier material needs to be regenerated or replaced, the whole inner container needs to be removed from the container in order to be able to reach the purifier. When the inner container is taken from the container, the inside of the container is exposed to an atmospheric condition. Due to the pollution on the inside of the container thus occurring, it is required to clean the container afterwards. Further, for a user, it is not possible to observe from an outside of the gas bottle whether purifier means are indeed included in the gas bottle, so that it can only be assumed that they will be present. This involves a certain risk, since the absence of purifier means can cause a strong pollution of a processing system connected to the gas bottle. This can lead to delay in the process due to the necessary cleaning of the system or even to defects in the system. Also when purifier means are not regenerated or exchanged in time, this can occur. However, it cannot be seen on an outside of the container whether this is needed. For regeneration of the purifier material, with the known gas bottle, the inner container can be removed and then be heated and/or be washed with a gas. This is time-consuming and also requires cleaning of the container. The above-described drawbacks are very essential with use of an Ultra High Purity Gas since exceeding the guaranteed amount of impurities therein is not desired due to the vulnerability of the equipment and/or systems connected thereto.

In order to obviate the above-mentioned drawbacks, the invention contemplates providing an improved gas bottle. More in particular, the invention contemplates providing a gas bottle where the purifier material can be exchanged and/or regenerated in an efficient manner, while the gas bottle is at the same time safe to use.

To this end, the invention provides a gas bottle according to the type described in the introduction, characterized in that the purifier is provided downstream of the outlet opening and upstream of the shut-off valve on an outside of the container, while the gas bottle with the purifier is arranged such that it can resist a load exerted thereon. Because the purifier is located on an outside of the container, it is easily accessible and it can simply be observed. Therefore exchanging the purifier or removing the purifier material for regeneration can simply be realized. Further, it is not necessary to heat and wash out the whole gas bottle for regenerating the purifier material. Because the gas bottle can resist a load exerted thereon, the gas bottle provided with an external purifier meets safety requirements for such gas bottles set in various norms and standards and is therefore safe to use. Here, it should be noted that the above-mentioned purifier is a purifier arranged for removing particles and impurities from the pure gas such that an Ultra High Purity Gas is obtained with a purity of up to substantially 99.999999999% or, in other words, with an impurity up to substantially 1 ppb (1 particle per a billion particles). Such an Ultra High Purity Gas may, for instance, be used in nanotechnology.

A load may be a mechanical load, for instance a shock load or an impact load. Such a load may, for instance, occur during the transport of gas bottles, when the gas bottles bump against one another, bump against the truck, or even fall from a truck.

According to a further elaboration of the invention, the gas bottle is provided with a protective element for protecting the outlet opening, the shut-off valve and the purifier in that it at least partly surrounds them.

Preferably, according to a further elaboration of the invention, the gas bottle is designed to be so strong that it remains intact in a fall from a truck moving at a speed of about 80 km/hour. Further, the gas bottle preferably needs to be able to resist a pressure of 750 bar or more before bursting of the gas bottle takes place.

According to a further elaboration of the invention, upstream of the purifier and downstream of the container, a pressure-reducing valve is provided, with a downstream effective surface of the pressure-reducing valve being larger than an upstream effective surface of the pressure-reducing valve. Such a valve, with a difference in surface on the two sides of the valve, brings about a difference in pressure of the gas present in the purifier with respect to the pressure of the gas present in the container. The lower pressure of the gas in the purifier reduces the risk of gas comprising impurities flowing back to the container, which impurities are present in the purifier, and therefore promotes the purifying action of the purifier. It is further known that gas bottles are generally rusty on an inside of the container, or at least contain pollutions on/in the wall, so that, at a high pressure, other impurities such as for instance water, oxygen or hydrocarbons adhere strongly to the inner wall of the container or diffuse therein. When the pressure in the container of the gas bottle decreases because gas from the gas bottle is used, these impurities will finally end up in the gas so that the purity of the gas decreases. Because a pressure difference occurs due to the presence of the pressure-reducing valve, at a relatively low pressure in the container, the pressure-reducing valve will no longer allow any gas through to the purifier. As a result, the relatively less pure gas remains behind in the bottle and unnecessary pollution of the purifier material and any devices and systems connected to the gas bottle is prevented. The pressure-reducing valve thus acts as a sort of first purifier for the gas to be used. An effective pressure difference is obtained due to a right ratio between the different surfaces, with the ratio of the upstream surface to the downstream surface preferably being in the range of 1:2 and 1:10, and more particularly preferably being 1:4.

According to a further elaboration of the invention, the shut-off valve is included in a tap body, which tap body has an inlet and an outlet, while the tap body has its inlet detachably connected with the outlet of the gas bottle, while, to the outlet of the tap body, a regulator, a gas pipe system or similar devices are connectable. To the tap body, a pressure regulator, an apparatus, a gas pipe system or, for instance, a processing system can be connected in which the Ultra High Purity Gas is needed. The tap body may be arranged in different manners and the purifier and the protective element may also be designed in different manners, while both the action of the gas bottle and the strength and safety of the purifier and the protective element are guaranteed. In a further embodiment of the invention, the purifier may, for instance, comprise an exchangeable purifier. The purifier may, for instance, be fastened to the tap body, but may also be included in the tap body between the outlet opening of the container of the gas bottle and the outlet of the tap body. It is also possible that the purifier is part of the protective element, while, according to a further elaboration of the invention, the purifier comprises a purifier chamber filled with purifier material included in the protective element. The protective element then forms the purifier, as it were, with the side of the protective element facing the container being connected to the outlet opening of the container and with the purifier material being in fluid connection with the contents of the container. In this embodiment, between the purifier chamber and the container, the above-described pressure-reducing valve can be provided. Further, according to a further elaboration, it is possible to arrange the protective element such that the protective element is a protective element formed around the purifier means and/or the shut-off valve.

In order to allow the purifier material to be observed still more easily, according to a further elaboration of the invention, the purifier may be provided with a sight glass. This allows the presence of the purifier and the purifier material to be checked easily, as well as the state in which the purifier material is. Thus an additional check is realized, which is favorable for the safety of the gas bottle. Further, according to a further elaboration of the invention, the purifier may be provided with an indicator observable via the sight glass. Such an indicator can indicate to what extent the purifier material is saturated, so that it can be determined whether the gas bottle can be filled again or whether regeneration of the purifier material or even exchanging the purifier is necessary. Such an indicator may, for instance, be an indicator purifier material which is provided downstream of the purifier material of the purifier. The indicator purifier material can indicate by means of a color change that the purifier material of the purifier is saturated. The indicator purifier material, which for instance comprises indicator beads, may have a particular color, for instance a green color. When the gas flows through the purifier material of the purifier and the purifier material is saturated, particles and/or impurities in the gas will reach the indicator purifier material. Because particles and/or impurities are removed from the gas by the indicator purifier material and consequently end up in the indicator purifier material, the indicator purifier material changes from the particular color to a different particular color, for instance from green to for instance blue. This is referred to as the color change of the indicator. This color change brings about a simple visual observation of the indicator and therefore of the moment the purifier material of the purifier needs to be exchanged or regenerated. It is clear that this color change can easily be seen if the purifier is located outside the container.

Further, according to a further elaboration of the invention, the purifier may be provided with a transponder. This may, for instance, be an RFID transponder (RFID=radio frequency identification). It may, for instance, be stored in the memory how often the container has already been filled with new gas. In addition, it can thus be monitored whether the purifier material already needs to be regenerated or whether the purifier needs to be replaced.

It is clear that the purifier may have different shapes and dimensions. Thus, according to a further elaboration of the invention, the purifier may comprise purifier material included in a purifier chamber provided in the tap body, which purifier chamber, on a first side, is in fluid connection with the outlet opening of the container and, on a second side, is in fluid connection with the shut-off valve in the tap body. Here, the purifier material may be provided around a part of the shut-off valve in the tap body.

So, with such a construction, the purifier means are integrated in the tap, so that fewer separate parts are necessary.

According to a further elaboration of the invention, the shut-off valve is a control valve, which is arranged for controlling at least one flow path through at least the tap. Because at least one valve is provided in the tap, it is possible to use the tap for letting the gas out of the gas bottle, but also for filling the gas bottle via the tap opening.

In a further elaboration of the invention, the flow path may be a first path extending from an interior of the container via at least the pressure-reducing valve and the purifier for supplying the gas to a point of use provided near the tap body outlet or a second path extending from the tap body outlet via the outlet opening of the container to the interior of the container for filling the container. Such a tap body obviates extra preparatory operations, so that the gas bottles can simply be filled. Preparatory operations may, for instance, involve removing the tap from the gas bottle and temporarily providing a filling nozzle on the gas bottle. It is clear that such operations are unfavorable for the filling process of the gas bottles.

It is possible to include a closable washing opening to the outside environment in the second flow path or in the container. Upon again filling the container with gas, the washing opening can temporarily be opened to first wash out the more polluted gases still present in the container with clean gas pressed into the container via the tap body outlet. Thus, the concentration of the pollutions in the gas still present in the container is reduced.

In order to easily reach the purifier means, according to a further elaboration of the invention, the protective element is at least partly removable in order to replace the purifier. Also, in a further embodiment of the invention, the protective element and the purifier and/or the tap body may be removable for regenerating the purifier means, while the outlet opening of the container is provided with closing means in order to close off the contents of the container in removed condition. In this manner, the purifier material may, for instance, easily be heated and be washed to remove the impurities accumulated in the purifier material. Further, when at least the purifier is removed, the contents of the container are protected by means of closing means, so that the contents of the container are not exposed to atmospheric conditions and are therefore not polluted. The contents of the container remain present in the container and can be used further after the whole of tap body, purifier and/or protective element is provided on the container again after regeneration or exchange.

The invention further relates to a protective element for use on an above-described gas bottle, where the protective element comprises fastening means for fastening on the gas bottle, while the protective element contains a purifier chamber filled with purifier material which is in fluid connection with container contents of the gas bottle on a first side of the protective element in a condition of being fastened on the gas bottle, and which is in fluid connection with a shut-off valve provided in the protective element on a second side of the protective element for supplying the gas.

According to a further elaboration of the invention, upstream of the purifier chamber, in the protective element, a pressure-reducing valve is provided, while a downstream effective surface of the pressure-reducing valve is larger than an upstream effective surface of the pressure-reducing valve.

Preferably, the ratio of the upstream surface to the downstream surface is in the range of 1:2 and 1:10, and is preferably 1:4.

Such a protective element offers the same advantages and effects as those mentioned and described hereinabove with reference to the gas bottle.

The invention further relates to a purifier evidently intended for use with an above-described gas bottle.

Further elaborations of the invention are described in the subclaims and will be explained hereinafter, with reference to the drawings, in which:

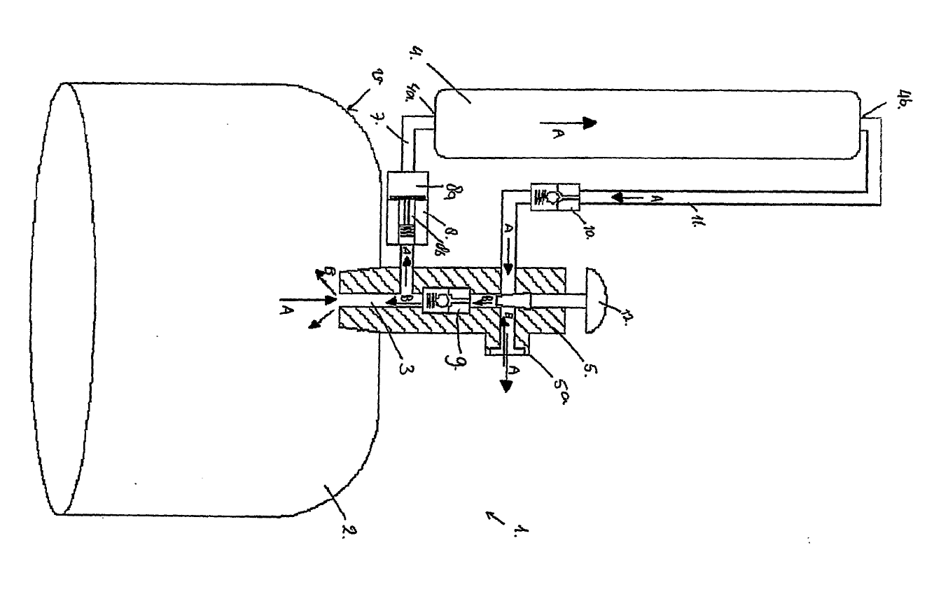

FIG. 1 shows a schematic cross-sectional view of a gas bottle according to an embodiment of the invention;

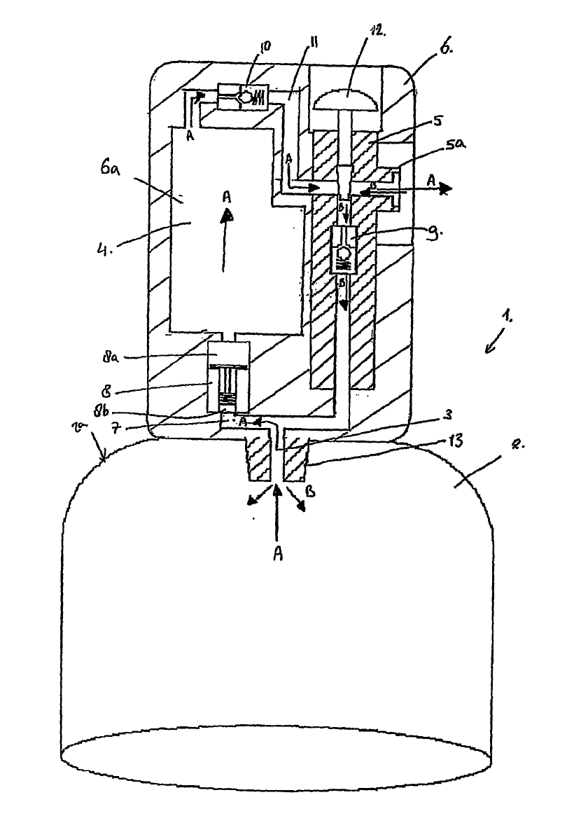

FIGS. 2a-2b schematically show different embodiments of a combination of the protective element, the tap and the purifier means;

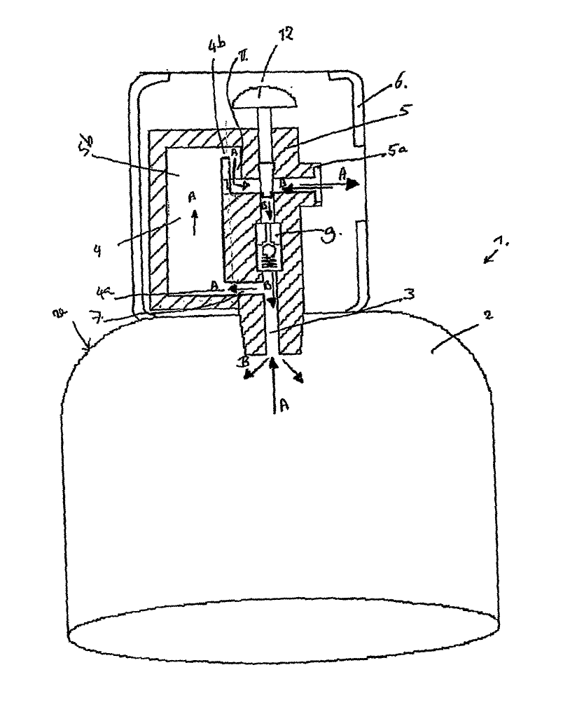

FIGS. 3a-3b schematically show a gas bottle according to a further embodiment of the invention; and

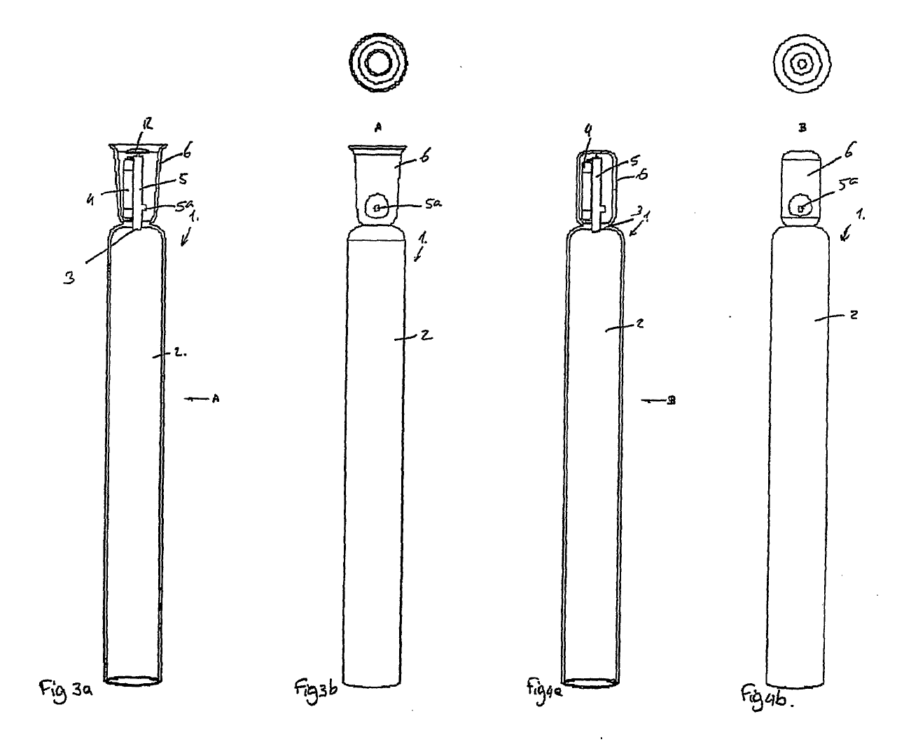

FIGS. 4a-4b schematically show a gas bottle according to a still further embodiment of the invention.

It is noted that same reference numerals designate same parts in the different Figures.

FIG. 1 shows a schematic cross-sectional view of a gas bottle 1 provided with a container 2, in which a gas, for instance an Ultra High Purity Gas, is included. Such as gas is, for instance, used in industrial processes, such as for instance processes under conditioned gas conditions or for instance in nanotechnology. The present invention is also important for gas bottles with medical or other uses. Examples of such gases are He, H₂, Ar, N₂, CO₂, NO, AsH₃, PH₃ and GeH₄. The container 2 has an outlet opening 3 for letting the gas out of the container 2. The gas bottle 1 further comprises a purifier 4 for operatively purifying the gas flowing out of the container 2. The purifier 4 is arranged for removing impurities from the Ultra High Purity Gas, so that, upon leaving the gas bottle 1, the gas has a purity of up to about 99.999999999%. This means that the gas has an impurity of substantially 1 ppb at most. Of course, the purifier 4 may be arranged for other uses for obtaining a gas with a lower purity, so with more particles than one particle per a billion particles. The purifier 4 is provided on an outside 2a of the container 2 and, in this exemplary embodiment, is fastened to a tap body 5 comprising a shut-off valve. Around the purifier means 4 and the tap body 5, a protective element 6 may be provided (not shown). To a tap body outlet 5a, devices or systems can be connected which are used in above-mentioned processes. In general, to the tap body outlet 5a, a pressure regulator will be connected. To this pressure regulator, generally a further gas pipe system is connected. The purifier 4 is arranged for removing a guaranteed amount of impurities from the gas, so that the gas leaving the purifier has a guaranteed purity. Impurities may, for instance, be metals, H₂O, CO, O₂, CO₂ and/or hydrocarbons. When too large an amount of these impurities is present in the gas, with use of the gas in processes, there is a risk of pollution of devices and systems. This causes unnecessary delay due to the cleaning thereof or the repair of any defects.

The purifier 4 and the tap body 5 can be surrounded by a protective element 6 (see for instance FIGS. 4a and 4b). The gas bottle 1 with the purifier 4 and the protective element 6 is arranged such that it can resist a load exerted thereon. A load, for instance a mechanical load such as a shock load or impact load, can occur during transport of the gas bottles 1 from the gas supplier to the user of the gas. Gas bottles 1 can bump against one another, or even fall from a truck, which can certainly also occur during unloading of the truck. Tests have shown that, when falling from a truck moving at a speed of 80 km/hour, the protective element 6 and the purifier means 4 do not deform, break or burst such that a safety risk occurs. Because the purifier 4 is provided on an outside 2a of the container 2, it can be reached relatively simply, which is favorable for exchanging or removing the purifier 4 or the purifier material present therein.

In a pipe 7 provided between the shut-off valve in the tap body 5 and the purifier 4, a pressure-reducing valve 8 is provided. The effective surface for the gas on the downstream side 8a of the pressure-reducing valve 8 is larger than the effective surface for the gas on the upstream side 8b of the pressure-reducing valve 8. As a result, the pressure of the gas is reduced after passing the pressure-reducing valve 8. Preferably, the ratio of the upstream surface 8b to the downstream surface 8a is 1:4. However, other ratios are also possible. The pressure reduction after passing the pressure-reducing valve 8 brings about an improved purifying action of the purifier 4 and at the same time prevents gas from flowing back from the purifier material to the container 2. This is favorable because then no impurities present in the purifier material end up in the container 2. Further, the pressure difference of the gas between the two sides of the pressure-reducing valve 8 ensures that, when the pressure of the gas in the container 2 drops below a particular value, the pressure-reducing valve 8 does not allow any more gas through to the purifier means 4. This is favorable since a last amount of gas in the container contains relatively many impurities. So, the pressure-reducing valve 8 in fact acts as a first purifier. The pressure-reducing valve 8 may be arranged in various manners, which are known to the average skilled person.

The tap body 5 is detachably connected with the outlet opening 3 of the container 2, for instance with the aid of a screw connection. It is favorable that the container 2 is provided with closing means (not shown) which automatically close off the outlet opening of the container after the tap 5 has been taken off. This prevents the contents of the container 2 from coming into contact with the atmospheric condition present around the container 2. The contents of the container 2 retain their quality and the container 2 does not need to be cleaned. In addition, these closing means provide an extra safety when the tap of the container comes off unintentionally. The tap body 5 comprises a control valve 6 for controlling flow paths A, B through the tap body 5. The flow paths comprise a first path A extending from an interior of the container 2 via at least the pressure-reducing valve 8, the purifier 4 and a second control valve 10 provided in the pipe 11 between the purifier 4 and the tap 5. The gas then leaves the tap body 5 via tap body outlet 5a and reaches a pressure regulator, device, system or the like connected to the tap body outlet 5a. When the gas moves along this flow path A, in the case of supplying the gas to the device, the control valve 9 in the tap body 5 is pushed to by the pressure of the gas, so that the gas is forced to continue on its way via the purifier 4. A second flow path B extends from the tap body outlet 5a, via the control valve 9 in the tap body 5 to the interior of the container 2, which path B is followed when the container is filled. For filling, the gas is supplied via the tap body outlet 5a, while, due to the gas pressure, the control valve 10 in the pipe 11 downstream of the purifier 4 closes, so that then the gas does not flow through the purifier 4. Optionally, in the second flow path B or in the container, a closable washing opening to the outside environment may be included. As already noted hereinabove, with the aid of such a washing opening, the gas containing more pollutions still present in the container can be washed with clean gas, so that the pollutions are removed from the container. The washing opening is preferably included in the second flow path in such a position that, during washing, no gases flow through the purifier or can flow from the purifier into the container.

In this exemplary embodiment, the purifier of the invention comprises an exchangeable purifier 4, which, on a first side 4a, is in fluid connection with the outlet opening 3 of the container 2. The second side 4b of the purifier 4 is in fluid connection with the tap body inlet 5a of the tap 5.

The assembly of the protective element 6, the tap body 5 and the purifier 4 may also be arranged in a different manner. In FIG. 2a, a cross-sectional view is shown of a second embodiment of the gas bottle 1 according to the invention. The protective element 6 is formed around the purifier 4 and the tap body 5. The purifier 4 contains purifier material in a purifier chamber 6a in the protective element 6. For the operation of the parts shown in FIG. 2a, reference is made to the description for FIG. 1. In another embodiment, it is possible that the protective element 6, the tap body 5 and/or the purifier 4 is provided with a sight glass through which the purifier material 4 is observable. Presence of the purifier material 4 can be checked and also the state in which the purifier material 4 is can be examined. Further, it is possible that an indicator is provided in the purifier 4, which indicator is, for instance, observable via the sight glass. Such an indicator may, for instance, indicate the degree of saturation of the purifier material 4, for instance with the aid of the above-described color change, but may also be arranged to indicate how often the gas bottle can still be filled before the purifier material 4 needs to be regenerated. Depending on the type of indicator, other characteristics may be shown and read out as well. Further, FIG. 2a shows that the protective element 6 comprises fastening means 13 for fastening the protective element 6 on the gas bottle 1. The fastening means 13 may, for instance, be a screw connection, but a quick-connect coupling is also possible.

FIG. 2b shows a further embodiment of the gas bottle 1 according to the invention. The purifier 4 comprises a purifier chamber 5b provided in the tap body 5, in which chamber purifier material is present. The purifier chamber 5b is in fluid connection with the gas in the container on a first side 4a and in fluid connection with the tap body outlet 5a on a second side 4b. Although not shown in FIG. 2b, it is clear that, also in this embodiment of the tap body 5, a pressure-reducing valve 8 can be provided for bringing about the pressure difference between the gas in the container 2 and the gas in the purifier 4. In the pipe 11 between the purifier 4 and the tap opening 5a, preferably a control valve is provided as well, which closes off the pipe 11 to the purifier 4 during filling of the gas bottle 1. The protective element 6 is a separate element provided around the tap body 5. The protective element 6 can be removed to reach the tap body 5 and optionally the purifier means 4. It is also possible that, in another embodiment, only a part of the protective element 6 is removable for reaching the purifier. Further, the protective element 6 and the tap body 5 are both removable from the container 2, which allows regeneration of the purifier material. The container 2 can comprise closing means so that, in removed condition, the contents of the container 2 are closed off from the container environment. In addition, these closing means provide an extra safety in case the tap body unintentionally comes off the container 2.

FIGS. 3a and 3b show an embodiment of the gas bottle 1 according to the invention, which gas bottle 1 is intended for use in, for instance, the United States, Asia and Japan. The protective element 6 has a so-called tulip shape, with the side facing away from the container 2 widening. FIGS. 4a and 4b show a same type of gas bottle 1, which is, however, for instance suitable for use in Europe. The protective element 6 has a different shape from the one in FIGS. 3a and 3b. It goes without saying that other shapes different from the above-discussed shapes also fall within the inventive concept.

It will be clear that the invention is not limited to the exemplary embodiment described but that various modifications are possible within the framework of the invention, as defined by the claims. Thus, the purifier may be provided around a part of the tap, with a first side of the purifier being in fluid connection with the outlet opening of the container and a second side being in fluid connection with the tap body outlet. Also, the purifier may comprise different types of purifier material or similar means known to a skilled person, depending on the type of impurities which need to be removed from the gas. Also, the purifier material may be arranged for obtaining different purities of the gas, so for instance from one or a few ppm (particles per million) to substantially one or a few ppb (particles per billion). This may, for instance, depend on the type of use of the gas. The separate elements such as the protective element, the tap and the purifier may be arranged with respect to one another in different manners, while they do retain the above-described functions and effects. Also, the gas bottle may have different shapes and dimensions. On or in the purifier, a transponder, such as for instance an RFID transponder with a memory, may be provided. In the memory, it may be stored how often the container has already been filled. In addition, it may be stored therein how much time still remains before the purifier material needs to be regenerated or replaced. Optionally, the outflow opening in the container and the channels in the tap body may be provided at an inclination with respect to the main longitudinal axis of the generally cylindrical container, so that, in the unlikely event of breaking off of the tap body, the gas flows out at an angle with respect to the main longitudinal axis of the cylindrical container. This prevents the gas bottle from shooting away in a straight path like a missile. Instead, the gas bottle will spin, which causes a less dangerous situation.

1. A gas bottle provided with a container in which a gas, for instance an Ultra High Purity Gas is receivable, with an outlet opening for letting the gas out of the container and a shut-off valve which is in fluid connection with the outlet opening, wherein the gas bottle is provided with a purifier for operatively purifying the gas flowing out of the container, characterized in that the purifier is provided downstream of the outlet opening and upstream of the shut-off valve on an outside of the container, wherein the gas bottle with the purifier is arranged such that it can resist a load exerted thereon.

2. A gas bottle according to claim 1, wherein the gas bottle comprises a protective element for protecting the outlet opening, the shut-off valve and the purifier in that it at least partly surrounds them.

3. A gas bottle according to claim 1, wherein the load is a mechanical load, for instance a shock load or an impact load.

4. A gas bottle according to claim 1, wherein, upstream of the purifier and downstream of the container, a pressure-reducing valve is provided, wherein a downstream effective surface of the pressure-reducing valve is larger than an upstream effective surface of the pressure-reducing valve.

5. A gas bottle according to claim 4, wherein the ratio of the upstream surface to the downstream surface is in the range of 1:2 and 1:10, and is preferably 1:4.

6. A gas bottle according to claim 1, wherein the shut-off valve is included in a tap body, which tap body has an inlet and an outlet, wherein the tap body has its inlet detachably connected with the outlet opening of the gas bottle, wherein, to the outlet of the tap body, a regulator, a gas pipe system or similar devices are connectable.

7. A gas bottle according to claim 6, wherein the purifier is an integral part of the tap body.

8. A gas bottle according to claim 1, wherein the purifier comprises an exchangeable purifier.

9. A gas bottle according to claim 1, wherein the purifier comprises a purifier chamber filled with purifier material included in the protective element.

10. A gas bottle according to claim 9, wherein the protective element is a protective element formed around the purifier and/or the shut-off valve.

11. A gas bottle according to claim 1, wherein the purifier is provided with a sight glass in order to be able to observe purifier material present therein.

12. A gas bottle according to claim 11, wherein the purifier is provided with an indicator which is observable via the sight glass.

13. A gas bottle according to claim 1, wherein the purifier is provided with a transponder.

14. A gas bottle according to claim 13, wherein the transponder is an RFID transponder with a memory.

15. A gas bottle according to claim 1, wherein the purifier material is provided at least around a part of the shut-off valve.

16. A gas bottle according to claim 1, wherein the purifier comprises purifier material which is included in a purifier chamber provided in the tap body, which purifier chamber, on a first side, is in fluid connection with the gas in the container and, on a second side, is in fluid connection with the shut-off valve in the tap body.

17. A gas bottle according to claim 1, wherein the shut-off valve is a control valve, which is arranged for controlling at least one flow path through the tap body.

18. A gas bottle according to claim 17, wherein the flow path is a first path extending from the interior of the container via at least the pressure-reducing valve and the purifier for the purpose of supplying the gas to a point of use provided near the outlet of the tap body or a second path extending from the tap body outlet via the outlet opening of the container to the interior of the container for filling the container.

19. A gas bottle according to claim 1, wherein the protective element is at least partly removable in order to replace the purifier.

20. A gas bottle according to claim 1, wherein the protective element and the purifier and/or the tap body are removable for regenerating the purifier material, wherein the outlet opening of the container is provided with closing means in order to close off the contents of the container in reduced condition.

21. A protective element for use on a gas bottle according to claim 1, wherein the protective element comprises fastening means for fastening on the gas bottle, wherein the protective element contains a purifier chamber filled with purifier material which, on a first side of the protective element, is in a condition in which it is fastened on the gas bottle, in fluid connection with container contents of the gas bottle and which, on a second side of the protective element, is in fluid connection with a shut-off valve provided in the protective element for supplying the gas.

22. A protective element according to claim 21, wherein, upstream of the purifier chamber, in the protective element, a pressure-reducing valve is provided, wherein a downstream effective surface of the pressure-reducing valve is larger than an upstream effective surface of the pressure-reducing valve.

23. A protective element according to claim 22, wherein the ratio of the upstream surface to the downstream surface is in the range of 1:2 and 1:10 and is preferably 1:4.

24. A purifier evidently intended for use with a gas bottle according to claim 1.

25. A gas bottle according to claim 2, wherein:
the load is a mechanical load, for instance a shock load or an impact load;
upstream of the purifier and downstream of the container, a pressure-reducing valve is provided, wherein a downstream effective surface of the pressure-reducing valve is larger than an upstream effective surface of the pressure-reducing valve;
the ratio of the upstream surface to the downstream surface is in the range of 1:2 and 1:10, and is preferably 1:4; and
the shut-off valve is included in a tap body, which tap body has an inlet and an outlet, wherein the tap body has its inlet detachably connected with the outlet opening of the gas bottle, wherein, to the outlet of the tap body, a regulator, a gas pipe system or similar devices are connectable.

26. A gas bottle according to claim 25, wherein the purifier is an integral part of the tap body.

27. A gas bottle according to claim 26, wherein the purifier comprises an exchangeable purifier.

28. A gas bottle according to claim 25, wherein:
the purifier comprises a purifier chamber filled with purifier material included in the protective element;
the protective element is a protective element formed around the purifier and/or the shut-off valve;
the purifier is provided with a sight glass in order to be able to observe purifier material present therein;
the purifier is provided with an indicator which is observable via the sight glass;
the purifier is provided with a transponder;
the transponder is an RFID transponder with a memory;
the purifier material is provided at least around a part of the shut-off valve;
the purifier comprises purifier material which is included in a purifier chamber provided in the tap body, which purifier chamber, on a first side, is in fluid connection with the gas in the container and, on a second side, is in fluid connection with the shut-off valve in the tap body;
wherein the shut-off valve is a control valve, which is arranged for controlling at least one flow path through the tap body;
the flow path is a first path extending from the interior of the container via at least the pressure-reducing valve and the purifier for the purpose of supplying the gas to a point of use provided near the outlet of the tap body or a second path extending from the tap body outlet via the outlet opening of the container to the interior of the container for filling the container;
the protective element is at least partly removable in order to replace the purifier; and
the protective element and the purifier and/or the tap body are removable for regenerating the purifier material, wherein the outlet opening of the container is provided with closing means in order to close off the contents of the container in reduced condition.

29. A protective element for use on a gas bottle according to claim 26, wherein the protective element comprises fastening means for fastening on the gas bottle, wherein the protective element contains a purifier chamber filled with purifier material which, on a first side of the protective element, is in a condition in which it is fastened on the gas bottle, in fluid connection with container contents of the gas bottle and which, on a second side of the protective element, is in fluid connection with a shut-off valve provided in the protective element for supplying the gas.

30. A protective element for use on a gas bottle according to claim 28, wherein the protective element comprises fastening means for fastening on the gas bottle, wherein the protective element contains a purifier chamber filled with purifier material which, on a first side of the protective element, is in a condition in which it is fastened on the gas bottle, in fluid connection with container contents of the gas bottle and which, on a second side of the protective element, is in fluid connection with a shut-off valve provided in the protective element for supplying the gas.

31. A purifier evidently intended for use with a gas bottle according to claim 25.

32. A purifier evidently intended for use with a gas bottle according to claim 28.
